(19) United States
(12) Patent Application Publication
(10) Pub. No.: US 2006/0218277 A1
(43) Pub. Date: Sep. 28, 2006

(54) Activating on-demand computer resources

(75) Inventor: Daniel Charles Birkestrand, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/089,467

(22) Filed: Mar. 24, 2005

(51) Int. Cl. G06F 15/173

(52) U.S. Cl. 709/226

(57) ABSTRACT

Methods, systems, and products are disclosed that operate generally to enable activating on-demand computer resources according to a customer's selection of resources, regardless of the type of computer resource to be activated and regardless of the type of activation. Systems according to embodiments of the present invention operate generally by receiving a generic enablement code and activating an on-demand computer resource in dependence upon the generic enablement code. A generic enablement code typically includes a maximum weighted measure of on-demand computer resource utilization. Activating an on-demand computer resource in dependence upon the generic enablement code may be carried out by activating an on-demand computer resource in dependence upon a maximum weighted measure of on-demand computer resource utilization and upon one or more weighting coefficients of on-demand computer resource utilization for one or more on-demand computer resources.

### BACKGROUND OF THE INVENTION

1. Field of the Invention

The field of the invention is data processing, or, more specifically, methods, systems, and products for activating on-demand computer resources.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer resource requirements for business and government applications often increase over a time period due to sales or employee growth. Over the same time period, the resource requirements may fluctuate dramatically due to inevitable peaks and valleys of day to day operations or from increased loads for seasonal, period-end, or special promotions. The peak resource requirements within a time period may be every different from the valley resource requirements. In order to be effective at all time, the computerized resources of a business must be sufficient to meet the current fluctuating needs of the business as well as projected needs due to growth.

To address such fluctuating and ever increasing resource demands, a customer conventionally purchases computing resources capable of accommodating at least its current peak requirement while planning for future requirements which are likely to be elevated. Customers therefore face the prospect of investing in more computerized resources than are immediately needed in order to accommodate growth and operational peaks and valleys. At any given time, therefore, the customer may have excess computing capacity—a very real cost. Such costs can represent a major expenditure for any computer customer.

To address this problem, computing architectures support ‘capacity on demand,’ allowing customers to own more computer resources than they have paid for. When the need for resources increases, due to a temporary peak demand or to permanent growth, customers may purchase or rent additional computer resources already installed on their computers. Such customers may obtain authorization in the form of security codes to activate these additional resources, called ‘on-demand computer resources,’ temporarily or permanently. Temporary activations may be of different types. A temporary activation may be ‘on/off,’ that is, an activation of a resource for a set period of time regardless of actual usage. A temporary activation may be a ‘reserve’ activation, that is, an activation effected only upon the detection of a predetermined level of demand. And a temporary activation may be a ‘trial’ activation, such as, for example, a promotional activation or a test activation at no charge to the customer.

Secure enablement codes for permanent activations of on-demand resources specify a numeric quantity of on-demand computer resources authorized for activation.

Enablement codes for temporary activations of on-demand computer resources specify an numeric quantity of resource utilization that represents utilization of a resource for a period of time, such as, for example, a processor-day or a gigabyte-day. For temporary activation, the customer is charged for each activation. The result is tremendous complexity: many enablement codes that system administrators must track and manage. In addition, this relatively rigid strategy does not allow a customer to alter in an economical way the quantity of resources or the relative ratios among quantities of resources to meet periodic, often daily or more frequent, up and downs in demand for resources. This rigid strategy is not dynamic enough to handle varying system loads. Processors, memory, and other resources cannot be added or removed from service without incurring an expense each time new resources are added.

### SUMMARY OF THE INVENTION

Methods, systems, and products are disclosed that operate generally to enable activating on-demand computer resources according to a customer's selection of resources, regardless of the type of computer resource to be activated and regardless of the type of activation. Systems according to embodiments of the present invention operate generally by receiving a generic enablement code and activating an on-demand computer resource in dependence upon the generic enablement code. A generic enablement code typically includes a maximum weighted measure of on-demand computer resource utilization. Activating an on-demand computer resource in dependence upon the generic enablement code may be carried out by activating an on-demand computer resource in dependence upon a maximum weighted measure of on-demand computer resource utilization and upon one or more weighting coefficients of on-demand computer resource utilization for one or more on-demand computer resources.

Activating an on-demand computer resource in dependence upon the generic enablement code may include activating an on-demand computer resource in dependence upon a customer-provided quantity of on-demand computer resources to be activated. Activating an on-demand computer resource in dependence upon a generic enablement code also may be carried out in dependence upon one or more on-demand computer resource activation parameters. Activating an on-demand computer resource in dependence upon the generic enablement code may include selecting a weighting coefficient of on-demand computer resource utilization for the resource in dependence upon one or more on-demand computer resource activation parameters. On-demand computer resource activation parameters may include computer type, one or more computer hardware features, and operating system type. Activating an on-demand computer resource in dependence upon the generic enablement code may include receiving a customer request for activation of a quantity of the on-demand computer resource and activating the requested quantity of the on-demand computer resource if the activating will result in a sum of products of weighting coefficients of on-demand computer resource utilization and corresponding activated quantities of on-demand computer resources no greater than a maximum weighted measure of on-demand computer resource utilization. Activating an on-demand computer resource in dependence upon the generic enablement code may include receiving a customer request for activation of a quantity of an on-demand computer resource and activating the requested quantity of on-demand computer resource only if the activation satisfies this expression:

$$M \geq {\sum }_{1}^{N} {W}_{i} \times {Q}_{i} ,$$

where M represents a maximum weighted measure of on-demand computer resource utilization, N represents a number of on-demand computer resources having weighting coefficients of on-demand computer resource utilization, Wᵢ represents a weighting coefficient of on-demand computer resource utilization for an i^{th} on-demand computer resource, and Qᵢ represents an activated quantity of utilization for an i^{th} on-demand computer resource.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for activating on-demand computer resources according to embodiments of the present invention.

FIG. 2 sets forth a network diagram illustrating a further exemplary system for activating on-demand computer resources according to embodiments of the present invention.

FIG. 3 sets forth a block diagram of automated computing machinery comprising an exemplary computer useful in activating on-demand computer resources according to embodiments of the present invention.

FIG. 4 sets forth a flow chart illustrating an exemplary method for activating on-demand computer resources according to embodiments of the present invention.

FIG. 5 sets forth a flow chart illustrating an exemplary method of activating an on-demand computer resource in dependence upon a generic enablement code.

FIG. 6 sets forth a flow chart illustrating a further exemplary method of activating an on-demand computer resource in dependence upon a generic enablement code.

FIG. 7A sets forth a line drawing of exemplary data structures useful in systems that activate on-demand according to embodiments of the present invention.

FIG. 7B sets forth a line drawing of an exemplary weighting coefficients table containing a number of weighting coefficient records.

FIG. 8 sets forth a line drawing that illustrates an exemplary on-demand resource activation tool implemented in a graphical user interface of a customer computer.

### DETAILED DESCRIPTION OF EXEMPLARY EMBODIMENTS

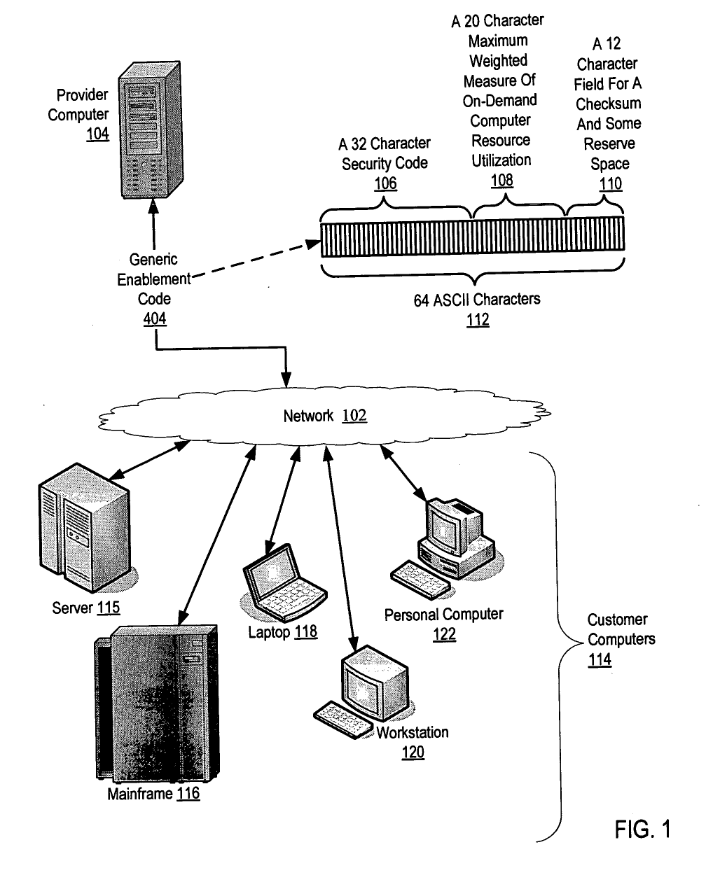

Exemplary methods, systems, and products for activating on-demand computer resources according to embodiments of the present invention are described with reference to the accompanying drawings, beginning with FIG. 1. FIG. 1 sets forth a network diagram illustrating an exemplary system for activating on-demand computer resources according to embodiments of the present invention. The system of FIG. 1 operates generally to activating on-demand computer resources according to embodiments of the present invention by communicating a generic enablement code (404) from a provider computer (104) to a customer computer (114) where the generic enablement code is received and used to activate on-demand computer resources.

A ‘provider’ is any entity that provides generic enablement codes for use in activating on-demand computer resources according to embodiments of the present invention. A provider may be the manufacturer of a customer's computer, an OEM or vendor of a customer's computer, a third party provider of activation services, or another entity as will occur to those of skill in the art. The term ‘customer computer’ is used in this specification to refer to any system configured to activate on-demand resources according to embodiments of the present invention. The system of FIG. 1 includes several exemplary customer computers (114), including a server (115), a mainframe (116), a laptop (118), a computer workstation (120), and a personal computer (122).

A generic enablement code is computer data configured to enable activation of on-demand computer resources regardless of the type of computer resource to be activated and regardless of the type of activation. Types of computer resources include any computer resource provided to a customer as an on-demand resource amenable to later activation, including, for example, processors, memory, input/output capacity, database metrics, additional licensed users, operating system modules, application programs, and so on as will occur to those of skill in the art. The generic enablement code (404) is structured as a string of 64 ASCII characters (112) divided into substrings that include a 32 character security code (106), a 20 character maximum weighted measure (108) of on-demand computer resource utilization, and 12 characters (110) for other uses, part of which here is reserved and part of which is used for a checksum. Clearly this is only one example of how to structure a generic enablement code, provided only for explanation, not for limitation. Any structure of a generic enablement code that will occur to those of skill in the art is well within the scope of the present invention.

In the system of FIG. 1, generic enablement code (404) is received by a customer computer via network (102). Delivering an enablement code via data communications across a network, however, is only for explanation, not a limitation of the present invention. In fact, generic enablement codes may be delivered to customers in a variety of ways, including for example, web postings via the HyperText Transmission Protocol (‘HTTP’), email, telephone, regular mail, and other ways as will occur to those of skill in the art.

The arrangement of computers making up the exemplary system illustrated in FIG. 1 is for explanation, not for limitation. Data processing systems useful for activating on-demand resources according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

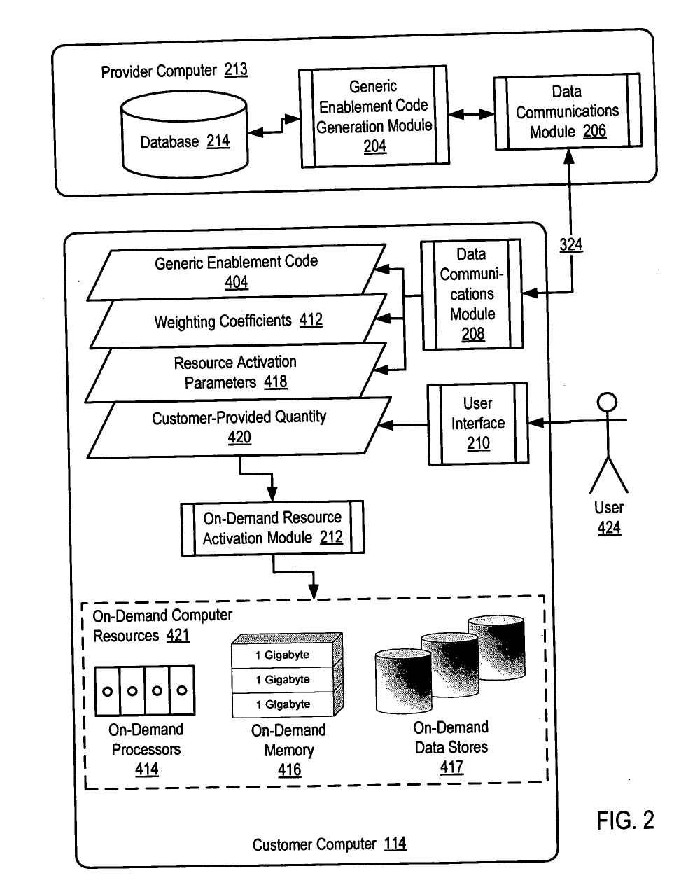

FIG. 2 sets forth a network diagram illustrating a further exemplary system for activating on-demand computer resources according to embodiments of the present invention. The system of FIG. 2 includes a provider computer (213) and a customer computer (114). The provider computer includes a generic enablement code generation module (204) that in turn includes computer program instructions to generate generic enablement codes and provide them to customers through a data communications module (206). The data communications link (324) in the example of FIG. 2 is a network coupling for data communications, although this is only for explanation. In fact, any method of communicating a generic enablement code from a provider to a customer is well within the scope of the present invention including, for example, email, regular mail, telephone conversation, postings from web sites, and so on, as will occur to those of skill in the art.

The customer computer (114) of FIG. 2 includes a data communications module (208) through which are received from a provider a generic enablement code (404), weighting coefficients (412) of on-demand computer resource utilization for one or more on-demand computer resources, and resource activation parameters (418). The customer computer (114) of FIG. 2 also includes a customer-provided quantity (420) of on-demand computer resources to be activated, entered by a user (424) through user interface (210). The customer computer (114) of FIG. 2 also includes several exemplary on-demand computer resources (421), including several on-demand processors (414), a quantity of on-demand memory (416), and several on-demand data stores (417).

The customer computer of FIG. 2 operates generally by receiving a generic enablement code (404) and activating an on-demand computer resource in dependence upon the generic enablement code. In the system of FIG. 2, the generic enablement code (404) typically includes a maximum weighted measure of on-demand computer resource utilization, as described above in the discussion of reference (108) of FIG. 1. In the system of FIG. 2, activating an on-demand computer resource in dependence upon the generic enablement code is carried out by activating on-demand computer resources in dependence upon a maximum weighted measure of on-demand computer resource utilization, upon one or more weighting coefficients of on-demand computer resource utilization for one or more on-demand computer resources, and upon a customer-provided quantity of on-demand computer resources to be activated.

More particularly, on-demand resource activation module (212), upon receiving a customer request for activation of a quantity of an on-demand computer resource, activates the requested quantity of the on-demand computer resource if the activating will result in a sum of products of weighting coefficients of on-demand computer resource utilization and corresponding activated quantities of on-demand computer resources no greater than a maximum weighted measure of on-demand computer resource utilization. This condition for activation of on-demand computer resources in the on-demand resource activation module (212) of customer computer (114) may be expressed as

$$M \geq {\sum }_{1}^{N} {W}_{i} \times {Q}_{i} , \qquad ( Exp . 1 )$$

where M represents a maximum weighted measure of on-demand computer resource utilization, N represents a number of on-demand computer resources having weighting coefficients of on-demand computer resource utilization, Wᵢ represents a weighting coefficient of on-demand computer resource utilization for an i^{th} on-demand computer resource, and Qᵢ represents an activated quantity of utilization for an i^{th} on-demand computer resource.

Weighting coefficients may vary in value according to resource type, activation type, and values of resource activation parameters. Activation type may include permanent activation or temporary activation, including on/off activation, reserve activation, or trial activation. Resource activation parameters may include any system characteristics that may affect the cost or value of an activation, including, for example, system type, system age, which operating system is in use with an activated resource, memory word size, memory bus type, peripheral bus type, processor size (32 bit or 64 bit, for example), and so on, as will occur to those of skill in the art. Weighting coefficients for use in determining whether to activate an on-demand computer resource when requested to do so may be selecting from a plurality of such coefficients in dependence upon resource type, activation type, and resource activation parameter values.

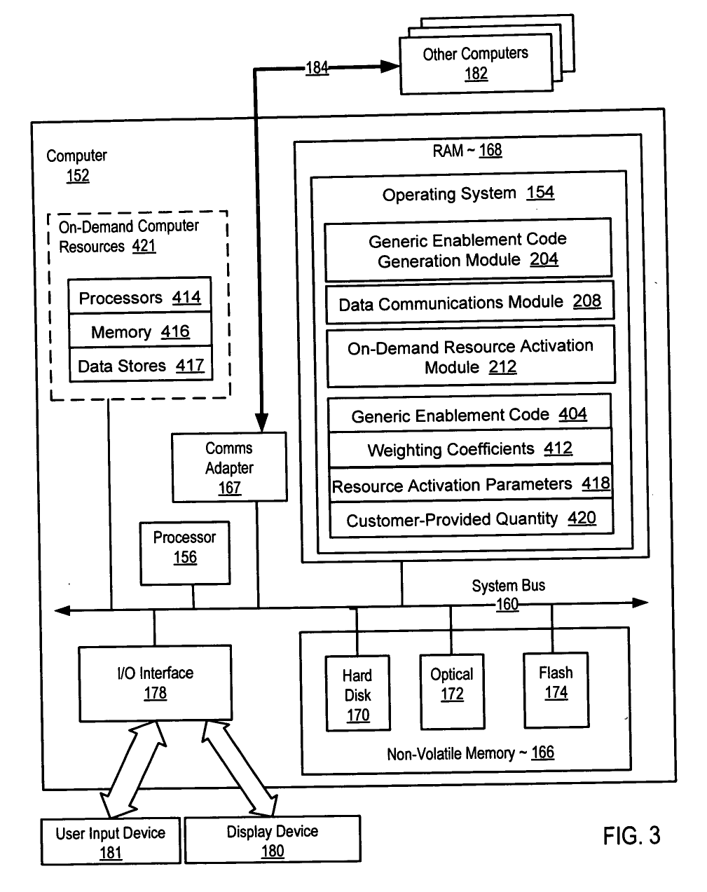

Activating on-demand computer resources in accordance with the present invention is generally implemented with computers, that is, with automated computing machinery. In the system of FIG. 1, for example, all the illustrated devices, servers, mainframe, communications devices, and provider computer, and other customer computers are implemented to some extent at least as computers. For further explanation, therefore, FIG. 3 sets forth a block diagram of automated computing machinery comprising an exemplary computer (152) useful in activating on-demand computer resources according to embodiments of the present invention. The computer (152) of FIG. 3 includes at least one computer processor (156) or ‘CPU’ as well as random access memory (168) (“RAM”) which is connected through a system bus (160) to processor (156) and to other components of the computer. The computer (152) of FIG. 3 also includes several exemplary on-demand computer resources (421), including on-demand processors (414), on-demand memory (416), and on-demand data stores (417).

Stored in RAM (168) is a generic enablement code generation module (204), computer program instructions for generating and providing to customer systems generic enablement codes for use in activating on-demand computer resources according to embodiments of the present invention. Also stored RAM (168) is a data communications module (208), computer program instructions for use in transmitting or receiving a generic enablement code for use in activating on-demand computer resources according to embodiments of the present invention. Also stored in RAM (168) is an on-demand resource activation module (212), computer program instructions that receive a generic enablement code and activate an on-demand computer resource in dependence upon the generic enablement according to embodiments of the present invention. Also stored in RAM (168) is a generic enablement code (404), weighting coefficients (412) of on-demand computer resource utilization for one or more on-demand computer resources, resource activation parameters (418), and a customer-provided quantity (420) of on-demand resources to be activated, all for activating on-demand computer resources according to embodiments of the present invention. On-demand resource activation module (212) is programmed to receive, store, and utilize in activating on-demand computer resources such generic enablement codes (404), weighting coefficients (412), resource activation parameters (418), and customer-provided quantities (420) of on-demand resources to be activated.

Also stored in RAM (168) is an operating system (154). Operating systems useful in computers according to embodiments of the present invention include UNIX™, Linux™, Microsoft NT™, AIX™, IBM's i5OS™, and many others as will occur to those of skill in the art. Operating system (154), generic enablement code generation module (204), data communications module (208), on-demand resource activation module (212), generic enablement code (404), weighting coefficients (412), resource activation parameters (418), and a customer-provided quantity (420) of on-demand resources to be activated in the example of FIG. 3 are shown in RAM (168), but many components of such software typically are stored in non-volatile memory (166) also.

In addition, generic enablement code generation module (204), data communications module (208), on-demand resource activation module (212), generic enablement code (404), weighting coefficients (412), resource activation parameters (418, and a customer-provided quantity (420) of on-demand resources to be activated in the example of FIG. 3 are shown as components of operating system (154). Persons of skill in the art will recognize, however, that in a system in which a hypervisor activates on-demand computer resources among multiple operating systems running in multiple logical partitions on the same system, some or all of the generic enablement code generation module (204), data communications module (208), on-demand resource activation module (212), generic enablement code (404), weighting coefficients (412), resource activation parameters (418), and a customer-provided quantity (420) of on-demand resources to be activated may be implemented as components of the hypervisor.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out through serially through RS-232 connections, through external buses such as USB, through data communications networks such as Internet Protocol networks, and in other ways as will occur to those of skill in the art. Communications adapters implement the hardware level of data communications through which one computer sends data communications to another computer, directly or through a network. Examples of communications adapters useful in activating on-demand resources according to embodiments of the present invention include modems for wired dial-up communications, Ethernet (IEEE 802.3) adapters for wired network communications, and 802.11b adapters for wireless network communications.

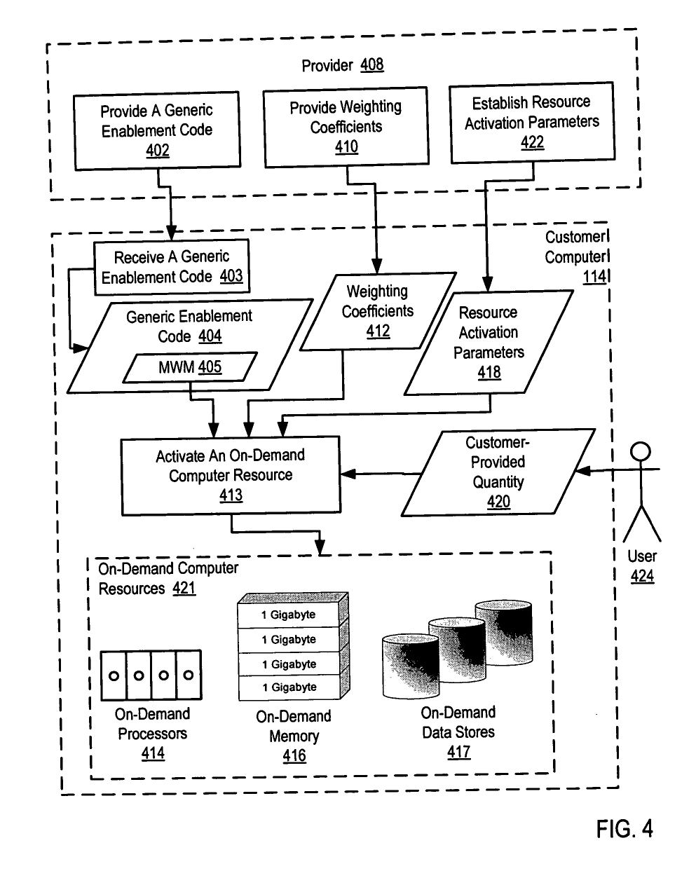

For further explanation, FIG. 4 sets forth a flow chart illustrating an exemplary method for activating on-demand computer resources according to embodiments of the present invention that includes receiving (403) a generic enablement code (404) and activating (413) an on-demand computer resource (421) in dependence upon the generic enablement code (404). In the method of FIG. 4, the generic enablement code further includes a maximum weighted measure (405) of on-demand computer resource utilization.

In the method of FIG. 4, activating (413) an on-demand computer resource in dependence upon the generic enablement code may include activating an on-demand computer resource in dependence upon a maximum weighted measure (405) of on-demand computer resource utilization and upon one or more weighting coefficients (412) of on-demand computer resource utilization for one or more on-demand computer resources. Just as a generic enablement code (403) is provided (402) by a provider (408), so also weighting coefficients (412) may be provided (410) by a provider (408). Weighting coefficients provide a convenient way to vary weighted measures of resource utilization across resource types so as to apply a single maximum weighted measure to a number of resources of many different types. Weighting measures therefore may be provided in an array, may be installed in read-only memory at the time of manufacturer, may be configured in a customer computer at the time of purchase or leasing, may be downloaded or updated from or by a provider at any time into customer random access memory or magnetic memory, and may otherwise be provided to a customer or installed on a customer computer in any way that will occur to those of skill in the art.

In the method of FIG. 4, activating (413) an on-demand computer resource in dependence upon the generic enablement code also may include activating an on-demand computer resource in dependence upon one or more on-demand computer resource activation parameters (418). Resource activation parameters provide a convenient way to vary weighted measures of resource utilization across system characteristics so as to apply a single maximum weighted measure across a wide range of computer hardware. Values for resource activation parameters (418) may be provided (422) by a provider (408) and received by a customer in a manner similar to the receipt of generic enablement codes and weighting coefficients, that is, by installation at the time of manufacture, by configuration at install time, by download or other delivery mechanism at any time, and so on.

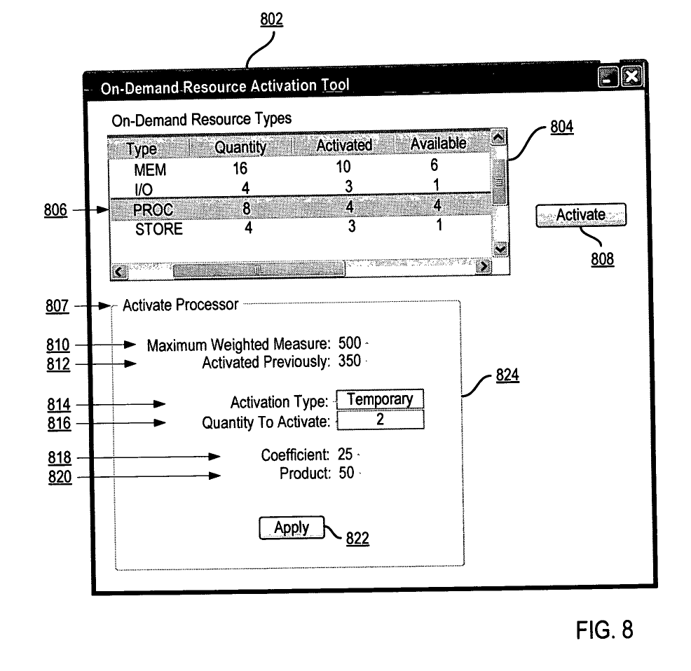

In the method of FIG. 4, activating (413) an on-demand computer resource in dependence upon the generic enablement code includes activating an on-demand computer resource in dependence upon a customer-provided quantity (420) of on-demand computer resources to be activated. A customer may provide a customer-provided quantity through a tool in a graphical user interface, such as, for example, the one described below with reference to FIG. 8.

In the method of FIG. 4, activating (413) an on-demand computer resource in dependence upon the generic enablement code may include selecting a weighting coefficient (412) of on-demand computer resource utilization for the resource in dependence upon a resource type or upon an activation type. In the method of FIG. 4, activating (413) an on-demand computer resource in dependence upon the generic enablement code may include selecting a weighting coefficient (412) of on-demand computer resource utilization for the resource in dependence upon resource type, upon activation type, or upon one or more on-demand computer resource activation parameters (418). In the method of FIG. 4, on-demand computer resource activation parameters (418) may include computer type, one or more computer hardware features, and operating system type, as well as other parameters as will occur to those of skill in the art.

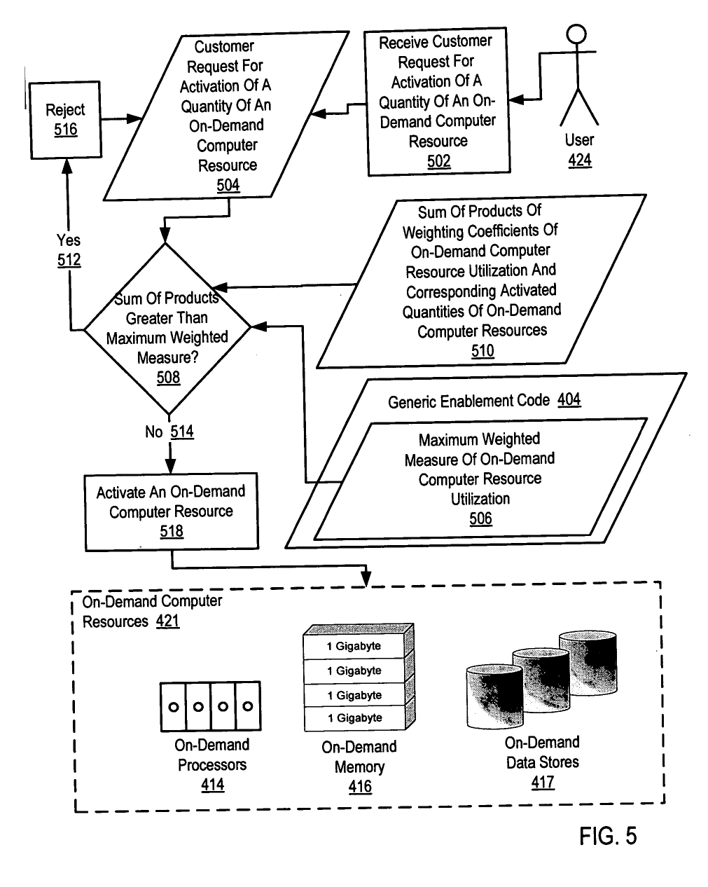

For further explanation, FIG. 5 sets forth a flow chart illustrating an exemplary method of activating (413 on FIG. 4) an on-demand computer resource in dependence upon a generic enablement code that includes receiving (502) a customer request (504) for activation of a quantity of the on-demand computer resource. The method of FIG. 5 includes activating (518) the requested quantity of the on-demand computer resource if (508) the activating will result (514) in a sum of products (510) of weighting coefficients of on-demand computer resource utilization and corresponding activated quantities of on-demand computer resources no greater than a maximum weighted measure (506) of on-demand computer resource utilization.

TABLE 1
Maximum Weighted Measure = 600

| | Resources: | | |
|---|---|---|---|
| | Processors | Memory | I/O Channels |
| Coefficients: | 50 | 25 | 20 |
| Quantity: | 4 | 12 | 3 |
| Product: | 200 | 300 | 60 |

Table 1 sets forth an example for explanation of activating an on-demand computer resource in dependence upon relations among a maximum weighted measure, weighting coefficients of on-demand computer resource utilization, and corresponding activated quantities of on-demand computer resources. Table 1 illustrates a customer computer system having a maximum weighted measure of on-demand computer resource utilization set to the value 600. The customer computer system has weighting coefficients of on-demand computer resource utilization for on-demand processors, on-demand memory, and on-demand I/O channels of 50, 25, and 20 respectively. The customer computer system has corresponding activated quantities of on-demand computer resources of 4 on-demand processors, 12 gigabytes on-demand memory, and 3 on-demand I/O channels.

In this example, the products of weighting coefficients of on-demand computer resource utilization and corresponding activated quantities of on-demand computer resources therefore are 200 for on-demand processors, 300 for on-demand memory, and 60 for on-demand I/O channels. The sum of the products of weighting coefficients of on-demand computer resource utilization and corresponding activated quantities of on-demand computer resources therefore is 200+300+60=560. In this example, an unactivated quantity of weighted measure of on-demand computer resource utilization may be expressed as 600−560=40, and new requests for activation of on-demand resources whose products of weighting coefficients of on-demand computer resource utilization and corresponding activated quantities of on-demand computer resources exceed this quantity will not be applied. That is, for example:
a request for activation of 1 additional processor, which in this example would have a product of weighting coefficient and corresponding activated quantity of 50×1=50, would not be allowed;
a request for activation of 2 additional gigabytes of memory, which in this example would have a product of weighting coefficient and corresponding activated quantity of 25×2=50, would not be allowed;
a request for activation of 1 additional gigabyte of memory, which in this example would have a product of weighting coefficient and corresponding activated quantity of 25×1=25, would be allowed;
a request for activation of 2 additional I/O channels, which in this example would have a product of weighting coefficient and corresponding activated quantity of 20×2=40, would be allowed; and
a request for activation of 3 additional I/O channels, which in this example would have a product of weighting coefficient and corresponding activated quantity of 20×3=60, would not be allowed.

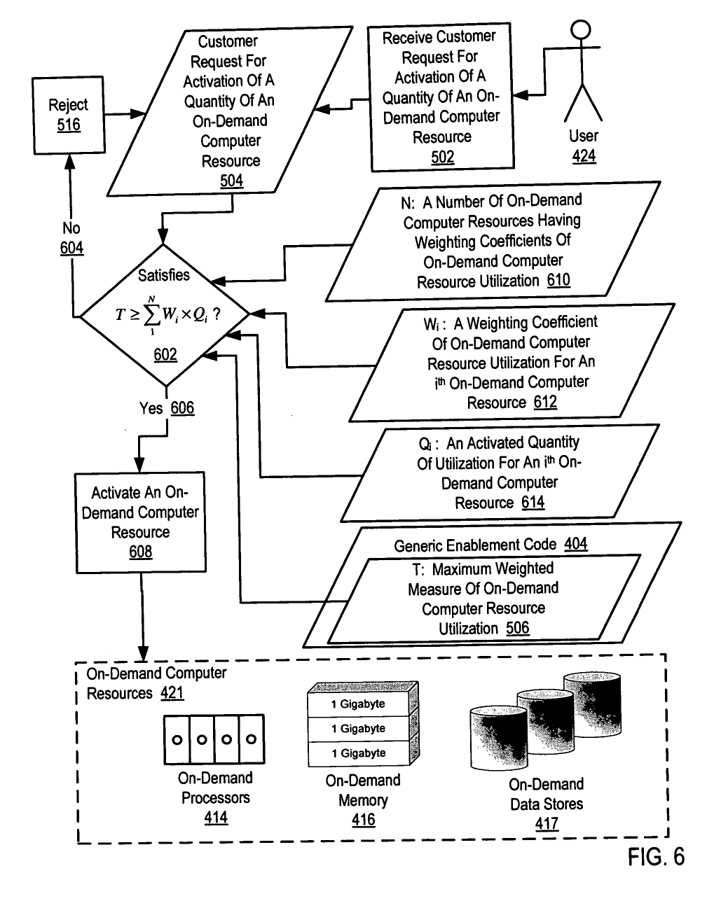

For further explanation, FIG. 6 sets forth a flow chart illustrating a further exemplary method of activating (413 on FIG. 4) an on-demand computer resource in dependence upon a generic enablement code that includes receiving (502) a customer request (504) for activation of a quantity of the on-demand computer resource. The method of FIG. 6 also includes activating (608) the requested quantity of on-demand computer resource only if (602) the activation satisfies (606) this expression:

$$M \geq {\sum }_{1}^{N} {W}_{i} \times {Q}_{i} ,$$

where M (506) represents a maximum weighted measure of on-demand computer resource utilization, N (610) represents a number of on-demand computer resources having weighting coefficients of on-demand computer resource utilization, Wᵢ (612) represents a weighting coefficient of on-demand computer resource utilization for an i^{th} on-demand computer resource, and Qᵢ (614) represents an activated quantity of utilization for an i^{th} on-demand computer resource.

Again consider the example of Table 1. In this example, T=600. N=3, because there are three computer resources having weighting coefficients of on-demand computer resource utilization: processors, memory, and I/O channels. Then, if these three resources are numbered sequentially:

W₁=50, Q₁=4,

W₂=25, Q₂=12,

W₃=20, Q₃=3,

and the sum of the products Wᵢ×Qᵢ is 560. Any request for activation of an additional on-demand resource whose activation will result in a sum of the products Wᵢ×Qᵢ greater than 600 will be rejected. That is, any request for activation of an additional on-demand resource whose sum of the products Wᵢ×Qᵢ is greater than 40 will be rejected.

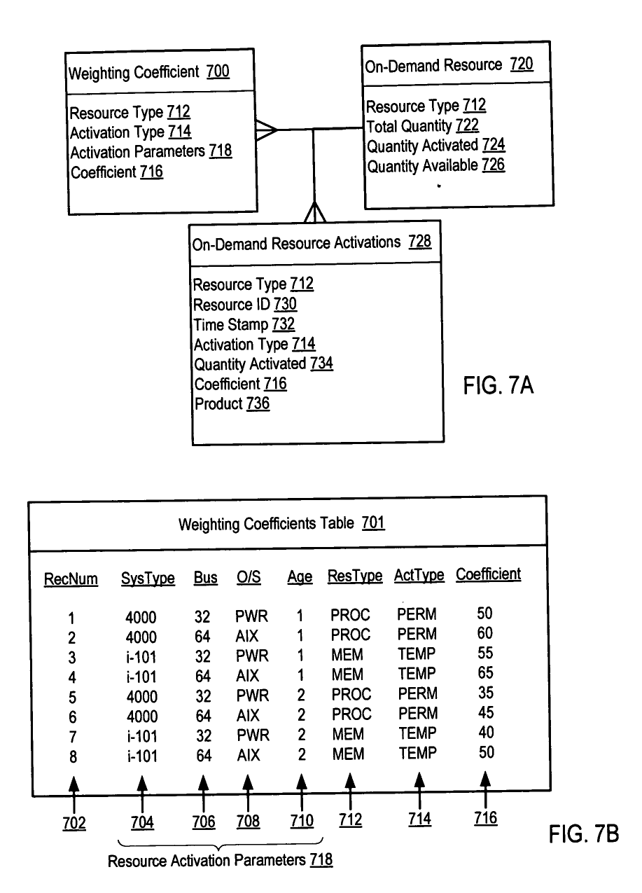

For further explanation, FIG. 7A sets forth a line drawing of exemplary data structures useful in systems that activate on-demand according to embodiments of the present invention. The exemplary data structures of FIG. 7A include a record structure for a weighting coefficient record (700), each instance of which may be used to represent a weighting coefficient of on-demand computer resource utilization for an on-demand computer resource. The weighting coefficient record (700) of FIG. 7A includes a resource type field (712), that may be used to record a resource type, for example, processor, memory, I/O channel, data store, and so on. The weighting coefficient record (700) of FIG. 7A also includes an activation type field (714), that may be used to record an activation type, for example, permanent, temporary, on/off, reserve, trial, and so on. The weighting coefficient record (700) of FIG. 7A also includes an activation parameters field (418), that may be used to record one or more activation parameters such as, for example, system type, system age, operating system, memory word size, memory bus type, peripheral bus type, processor size (32 bit or 64 bit, for example), and so on. The weighting coefficient record (700) of FIG. 7A also includes a coefficient field (716), that may be used to record a weighting coefficient of on-demand computer resource utilization for a on-demand computer resource. Recording resource type, activation type, and activation parameters together with weighting coefficients allows weighting coefficients to be sorted, indexed, and selected in dependence upon resource type, activation type, and activation parameter values.

The exemplary data structures of FIG. 7A include a record structure to represent an on-demand resource (720). The on-demand resource record (720) of FIG. 7A includes a resource type field (712), that may be used to record a resource type, for example, processor, memory, I/O channel, data store, and so on. The on-demand resource record (720) of FIG. 7A also includes fields for storing respectively the total quantity (722) of an on-demand resource installed on a customer computer, the quantity (724) of the resource that has been activated, and the quantity (726) remaining available for activation.

The exemplary data structures of FIG. 7A include a record structure to represent an activation of an on-demand resource (728). The on-demand resource activation record (728) of FIG. 7A includes a resource type field (712), that may be used to record a resource type, for example, processor, memory, I/O channel, data store, and so on. The on-demand resource record (720) of FIG. 7A also includes fields for storing respectively an identification code (730) for the particular resource activated, a time stamp (732) that records the date and time when a resource was activated, an activation type field (714) (indicating whether the activation was permanent, temporary, and so on), the quantity (734) of the resource activated in the activation represented by a particular instance of the on-demand resource activation record (728), the weighting coefficient (716) used for the particular activation (weighting coefficients can vary across activations of the same type of resource), and the product (736) of the quantity activated (734) and the weighting coefficient (716).

For further explanation, FIG. 7B sets forth a line drawing of an exemplary weighting coefficients table containing a number of weighting coefficient records similar to the one illustrated at reference (700) in FIG. 7A. Like the weighting coefficient record illustrated at reference (700) in FIG. 7A, the records in the weighting coefficients table (701) contain a resource type field (712), an activation type field (714), and a weighting coefficient field (716). Each record in weighting coefficients table (701) also contains a field storing a record number (702) as well as fields for four separate resource activation parameters (418): a system type field (704) used to indicate the model of the customer computer on which activations are to be carried out, a bus type field (706) used to indicate whether the main system bus supports 32 bits or 64 bit, an operating system field (708) used to indicate the kind of operating system running on the customer computer (in this case, ‘PWR’ for IBM's PowerPC OS or IBM's ‘AIX’), and the age (710) of the customer computer. The exemplary values set forth in weighting coefficients table (701) help to illustrate the fact that the weighted units of resource utilization charged by a system for on-demand activation according to embodiments of the present invention may vary according to:
the type of activation—when, for example, the weighting coefficient for a permanent activation may be less than the weighting coefficient for a temporary activation
the type of resource activated—the weighting coefficient for a processor on a customer computer may be different from the weighting coefficient for memory
resource activation parameter—weighting coefficients may decrease in value as a system ages, weighting coefficients for 64 bit memory or 64 bit processors may be higher than weighting coefficients for 32 bit memory or 32 bit processors, and weighting coefficients for resources on a PowerPC may be generally smaller than weighting coefficients for similar resources on a pSeries server.

For further explanation, FIG. 8 sets forth a line drawing that illustrates an exemplary on-demand resource activation tool (802) implemented in a graphical user interface of a customer computer. The tool is provided as part of an on-demand resource activation module such as the one illustrated at reference (212) of FIG. 2. When the tool is first accessed, it displays scrolling text box (804). Text box (804) displays a list of on-demand resource available for activation along with total quantities, quantities already activated, and quantities that remain available for activation. The data displayed in text box (804) may be derived from a table such as the one illustrated at reference (720) in FIG. 7A in which each record represents an on-demand resource or a type of on-demand resource.

In this example, a user has selected the on-demand resource ‘PROC’ or ‘processors’ (806) for activation. Mouse-clicking the ‘Activate’ button (808) causes the tool to display dialog box (824), which could not be displayed until after the user advise to tool of the type of resource to activate. When the tool knows the type of resource to activate, the tool may display the resource type (807). After the user enters the activation type (814), the tool may query a table such as, for example, the table illustrated at reference (700) in FIG. 7A or the table illustrated at reference (701) in FIG. 7B, to determine the applicable weighting coefficient (818) for display. The tool also displays the maximum weighted measure (810) for the customer computer and the sum (812) of the products of weighting coefficients and their corresponding activated quantities of on-demand computer resources.

In this way, a user can conveniently see that only those requests for activation of processors whose product of weighting coefficient and quantity to be activated is not greater than 150 will be accepted for activation. After the user enters the quantity to activate (816), the tool may display the product (820) weighting coefficient and quantity to be activated. Then when the user invokes the ‘Apply’ button (822), the tool accepts the user input as a request to activate a quantity of an on-demand computer resource, in this case 2 processors, and activates that requested quantity of the on-demand computer resource if the activating will result in a sum of products of weighting coefficients of on-demand computer resource utilization and corresponding activated quantities of on-demand computer resources no greater than the maximum weighted measure of on-demand computer resource utilization for this customer computer, that is, no greater than 500.

In view of the these explanations and examples, readers will understand that the benefits of activating on-demand computer resources according to embodiments of the present invention include the ability for customer's system administrators to dynamically increase or decrease the number of activated on-demand processors, the quantity of activated on-demand memory, and quantities of other on-demand resources so long as the overall measure of resources activated remains within the bounds set by a generic enablement code. Activating few processors or deactivating on-demand processors automatically makes available for activation a larger quantity of on-demand memory. Activating less on-demand memory or deactivating on-demand memory automatically makes available more I/O channels. And so on.

For further explanation of the advantages of activating on-demand computer resources according to embodiments of the present invention, consider a exemplary use case. In this example, a customer computer is used during the day to accept and process orders for goods from purchasers. At night, the customer computer is used for batch processing of ledger postings and other calculations in an accounting system. During the day, the computer is I/O bound. At night, it is processor-bound. The quantity of on-demand I/O capacity needed to meet the daytime requirement is 10. The quantity of on-demand I/O capacity needed to meet the nighttime requirement is 10. Under prior art, the customer would need to purchase 20 units of on-demand computer resources because under old art, the customer must buy the maximum needed to meet all peak demands. In activating on-demand computer resources according to embodiments of the present invention, the customer only needs to purchase 10 units of on-demand resource capacity. The customer can then activate 10 on-demand units of I/O capacity during the day, deactivating that capacity at night and replacing it with 10 units of processor capacity. In addition, the customer needs only one generic enablement code to support these activations.

Exemplary embodiments of the present invention are described largely in the context of fully functional computer systems for activating on-demand computer resources. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for activating on-demand computer resources, the method comprising:
receiving a generic enablement code; and
activating an on-demand computer resource in dependence upon the generic enablement code.

2. The method of claim 1 wherein the generic enablement code further comprises a maximum weighted measure of on-demand computer resource utilization.

3. The method of claim 1 wherein activating an on-demand computer resource in dependence upon the generic enablement code further comprises activating an on-demand computer resource in dependence upon a maximum weighted measure of on-demand computer resource utilization and upon one or more weighting coefficients of on-demand computer resource utilization for one or more on-demand computer resources.

4. The method of claim 1 wherein activating an on-demand computer resource in dependence upon the generic enablement code further comprises activating an on-demand computer resource in dependence upon a customer-provided quantity of on-demand computer resources to be activated.

5. The method of claim 1 wherein activating an on-demand computer resource in dependence upon the generic enablement code further comprises activating an on-demand computer resource in dependence upon one or more on-demand computer resource activation parameters.

6. The method of claim 1 wherein activating an on-demand computer resource in dependence upon the generic enablement code further comprises selecting a weighting coefficient of on-demand computer resource utilization for the resource in dependence upon one or more on-demand computer resource activation parameters.

7. The method of claim 6 wherein on-demand computer resource activation parameters further comprise computer type, one or more computer hardware features, and operating system type.

8. The method of claim 1 wherein activating an on-demand computer resource in dependence upon the generic enablement code further comprises:
receiving a customer request for activation of a quantity of the on-demand computer resource; and
activating the requested quantity of the on-demand computer resource if the activating will result in a sum of products of weighting coefficients of on-demand computer resource utilization and corresponding activated quantities of on-demand computer resources no greater than a maximum weighted measure of on-demand computer resource utilization.

9. The method of claim 1 wherein activating an on-demand computer resource in dependence upon the generic enablement code further comprises:
receiving a customer request for activation of a quantity of an on-demand computer resource; and
activating the requested quantity of on-demand computer resource only if the activation satisfies this expression:
$$M \geq {\sum }_{1}^{N} {W}_{i} \times {Q}_{i} , wherein \text{:}$$
M represents a maximum weighted measure of on-demand computer resource utilization;
N represents a number of on-demand computer resources having weighting coefficients of on-demand computer resource utilization;
Wᵢ represents a weighting coefficient of on-demand computer resource utilization for an i^{th} on-demand computer resource; and
Qᵢ represents an activated quantity of utilization for an i^{th} on-demand computer resource.

10. An apparatus for activating on-demand computer resources, the apparatus comprising:
at least one computer processor;
at least one computer memory operatively coupled to the computer processor; and
computer program instructions disposed within the computer memory and capable of receiving a generic enablement code and activating an on-demand computer resource in dependence upon the generic enablement code.

11. The apparatus of claim 10 wherein the generic enablement code further comprises a maximum weighted measure of on-demand computer resource utilization.

12. The apparatus of claim 10 wherein activating an on-demand computer resource in dependence upon the generic enablement code further comprises activating an on-demand computer resource in dependence upon a maximum weighted measure of on-demand computer resource utilization and upon one or more weighting coefficients of on-demand computer resource utilization for one or more on-demand computer resources.

13. The apparatus of claim 10 wherein activating an on-demand computer resource in dependence upon the generic enablement code further comprises activating an on-demand computer resource in dependence upon a customer-provided quantity of on-demand computer resources to be activated.

14. The apparatus of claim 10 wherein activating an on-demand computer resource in dependence upon the generic enablement code further comprises activating an on-demand computer resource in dependence upon one or more on-demand computer resource activation parameters.

15. The apparatus of claim 10 wherein activating an on-demand computer resource in dependence upon the generic enablement code further comprises selecting a weighting coefficient of on-demand computer resource utilization for the resource in dependence upon one or more on-demand computer resource activation parameters.

16. The apparatus of claim 15 wherein on-demand computer resource activation parameters further comprise computer type, one or more computer hardware features, and operating system type.

17. The apparatus of claim 10 wherein activating an on-demand computer resource in dependence upon the generic enablement code further comprises:
receiving a customer request for activation of a quantity of the on-demand computer resource; and
activating the requested quantity of the on-demand computer resource if the activating will result in a sum of products of weighting coefficients of on-demand computer resource utilization and corresponding activated quantities of on-demand computer resources no greater than a maximum weighted measure of on-demand computer resource utilization.

18. The apparatus of claim 10 wherein activating an on-demand computer resource in dependence upon the generic enablement code further comprises:
receiving a customer request for activation of a quantity of an on-demand computer resource; and
activating the requested quantity of on-demand computer resource only if the activation satisfies this expression:
$$M \geq {\sum }_{1}^{N} {W}_{i} \times {Q}_{i} , wherein \text{:}$$
M represents a maximum weighted measure of on-demand computer resource utilization;
N represents a number of on-demand computer resources having weighting coefficients of on-demand computer resource utilization;
Wᵢ represents a weighting coefficient of on-demand computer resource utilization for an i^{th} on-demand computer resource; and
Qᵢ represents an activated quantity of utilization for an i^{th} on-demand computer resource.

19. A system for activating on-demand computer resources, the system comprising:
means for receiving a generic enablement code; and
means for activating an on-demand computer resource in dependence upon the generic enablement code.

20. The system of claim 19 wherein the generic enablement code further comprises a maximum weighted measure of on-demand computer resource utilization.

21. The system of claim 19 wherein means for activating an on-demand computer resource in dependence upon the generic enablement code further comprises means for activating an on-demand computer resource in dependence upon a maximum weighted measure of on-demand computer resource utilization and upon one or more weighting coefficients of on-demand computer resource utilization for one or more on-demand computer resources.

22. The system of claim 19 wherein means for activating an on-demand computer resource in dependence upon the generic enablement code further comprises means for activating an on-demand computer resource in dependence upon a customer-provided quantity of on-demand computer resources to be activated.

23. The system of claim 19 wherein means for activating an on-demand computer resource in dependence upon the generic enablement code further comprises means for activating an on-demand computer resource in dependence upon one or more on-demand computer resource activation parameters.

24. The system of claim 19 wherein means for activating an on-demand computer resource in dependence upon the generic enablement code further comprises means for selecting a weighting coefficient of on-demand computer resource utilization for the resource in dependence upon one or more on-demand computer resource activation parameters.

25. The system of claim 24 wherein on-demand computer resource activation parameters further comprise computer type, one or more computer hardware features, and operating system type.

26. The system of claim 19 wherein means for activating an on-demand computer resource in dependence upon the generic enablement code further comprises:
means for receiving a customer request for activation of a quantity of the on-demand computer resource; and
means for activating the requested quantity of the on-demand computer resource if the activating will result in a sum of products of weighting coefficients of on-demand computer resource utilization and corresponding activated quantities of on-demand computer resources no greater than a maximum weighted measure of on-demand computer resource utilization.

27. The system of claim 19 wherein means for activating an on-demand computer resource in dependence upon the generic enablement code further comprises:
means for receiving a customer request for activation of a quantity of an on-demand computer resource; and
means for activating the requested quantity of on-demand computer resource only if the activation satisfies this expression:
$$M \geq {\sum }_{1}^{N} {W}_{i} \times {Q}_{i} , wherein \text{:}$$
M represents a maximum weighted measure of on-demand computer resource utilization;
N represents a number of on-demand computer resources having weighting coefficients of on-demand computer resource utilization;
Wᵢ represents a weighting coefficient of on-demand computer resource utilization for an i^{th} on-demand computer resource; and
Qᵢ represents an activated quantity of utilization for an i^{th} on-demand computer resource.

28. A computer program product for activating on-demand computer resources, the computer program product disposed upon a signal bearing medium, the computer program product comprising:
computer program instructions that receive a generic enablement code; and
computer program instructions that activate an on-demand computer resource in dependence upon the generic enablement code.

29. The computer program product of claim 28 wherein the signal bearing medium comprises a recordable medium.

30. The computer program product of claim 28 wherein the signal bearing medium comprises a transmission medium.

31. The computer program product of claim 28 wherein the generic enablement code further comprises a maximum weighted measure of on-demand computer resource utilization.

32. The computer program product of claim 28 wherein computer program instructions that activate an on-demand computer resource in dependence upon the generic enablement code further comprise computer program instructions that activate an on-demand computer resource in dependence upon a maximum weighted measure of on-demand computer resource utilization and upon one or more weighting coefficients of on-demand computer resource utilization for one or more on-demand computer resources.

33. The computer program product of claim 28 wherein computer program instructions that activate an on-demand computer resource in dependence upon the generic enablement code further comprise computer program instructions that activate an on-demand computer resource in dependence upon a customer-provided quantity of on-demand computer resources to be activated.

34. The computer program product of claim 28 wherein computer program instructions that activate an on-demand computer resource in dependence upon the generic enablement code further comprise computer program instructions that activate an on-demand computer resource in dependence upon one or more on-demand computer resource activation parameters.

35. The computer program product of claim 28 wherein computer program instructions that activate an on-demand computer resource in dependence upon the generic enablement code further comprise computer program instructions that select a weighting coefficient of on-demand computer resource utilization for the resource in dependence upon one or more on-demand computer resource activation parameters.

36. The computer program product of claim 35 wherein on-demand computer resource activation parameters further comprise computer type, one or more computer hardware features, and operating computer program product type.

37. The computer program product of claim 28 wherein computer program instructions that activate an on-demand computer resource in dependence upon the generic enablement code further comprise:
computer program instructions that receive a customer request for activation of a quantity of the on-demand computer resource; and
computer program instructions that activate the requested quantity of the on-demand computer resource if the activation will result in a sum of products of weighting coefficients of on-demand computer resource utilization and corresponding activated quantities of on-demand computer resources no greater than a maximum weighted measure of on-demand computer resource utilization.

38. The computer program product of claim 28 wherein computer program instructions that activate an on-demand computer resource in dependence upon the generic enablement code further comprise:
computer program instructions that receive a customer request for activation of a quantity of an on-demand computer resource; and
computer program instructions that activate the requested quantity of on-demand computer resource only if the activation satisfies this expression:
$$M \geq {\sum }_{1}^{N} {W}_{i} \times {Q}_{i} , wherein \text{:}$$
M represents a maximum weighted measure of on-demand computer resource utilization;
N represents a number of on-demand computer resources having weighting coefficients of on-demand computer resource utilization;
Wᵢ represents a weighting coefficient of on-demand computer resource utilization for an i^{th} on-demand computer resource; and
Qᵢ represents an activated quantity of utilization for an i^{th} on-demand computer resource.
